(19) United States
(12) Patent Application Publication
(10) Pub. No.: US 2014/0334088 A1
(43) Pub. Date: Nov. 13, 2014

(54) MOUNTING APPARATUS FOR EXPANSION CARD

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: LING LONG, Shenzhen (CN); LI-REN FU, Shenzhen (CN)

(73) Assignees: HON HAI PRECISION INDUSTRY CO., LTD., New Taipei (TW); HONG FU JIN PRECISION INDUSTRY (ShenZhen) CO., Shenzhen (CN)

(21) Appl. No.: 13/973,966

(22) Filed: Aug. 22, 2013

(30) Foreign Application Priority Data
May 10, 2013 (CN) 2013101695037

(51) Int. Cl. G06F 1/18

(52) U.S. Cl. CPC G06F 1/185
USPC 361/679.32

(57) ABSTRACT

A mounting apparatus for mounting an expansion card to a socket forming a flange includes a retaining member. The retaining member includes a mounting plate fixed to the expansion card, an operation portion extending from a side of the mounting plate, and a locking portion extending down from the operation portion and locked to the flange.

### BACKGROUND

1. Technical Field

The present disclosure relates to an apparatus for mounting expansion cards.

2. Description of Related Art

Computer systems require expansion cards to expand functions. An expansion card usually includes a main body electrically connectable to a motherboard in a computer system, without any retaining member to hold the expansion card stable.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting apparatus together with an expansion card, the mounting apparatus includes a retaining member.

FIG. 2 is an enlarged view of the retaining member of FIG. 1, but viewed from another perspective.

FIG. 3 is an enlarged view of the retaining member of FIG. 1.

FIG. 4 is an assembled view of FIG. 1.

### DETAILED DESCRIPTION

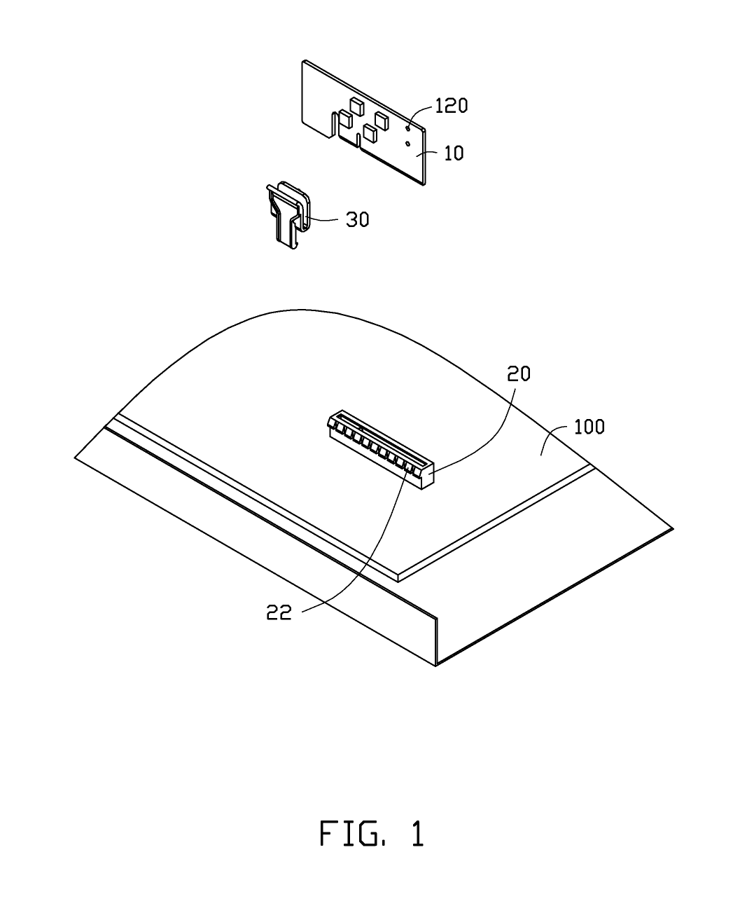

FIG. 1 shows an embodiment of a mounting apparatus for mounting an expansion card 10 to a socket 20 of a motherboard 100. The mounting apparatus includes a retaining member 30. The expansion card 10 defines two fixing holes 120. A wedge-shaped flange 22 extends out from a side of the socket 22.

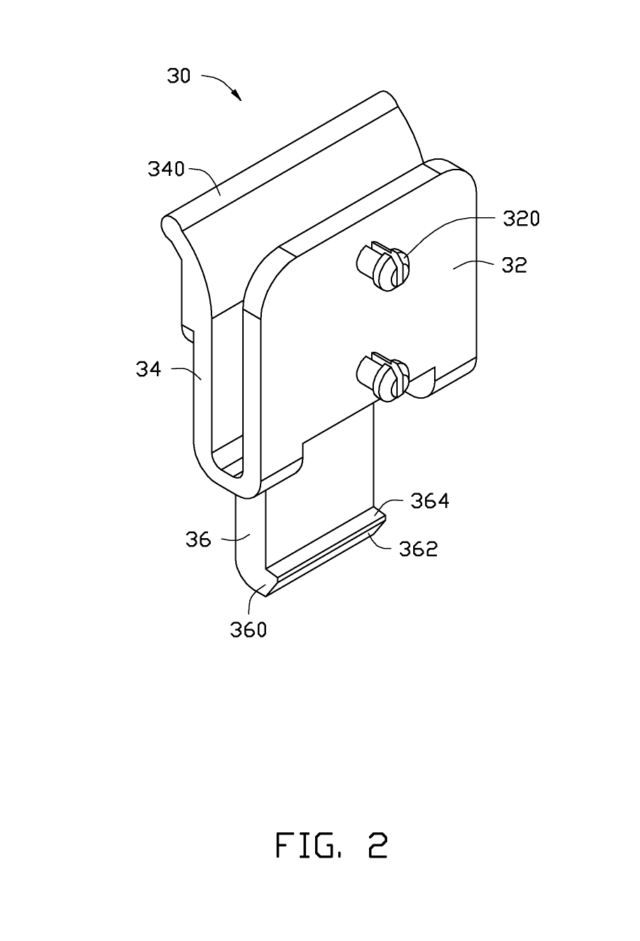

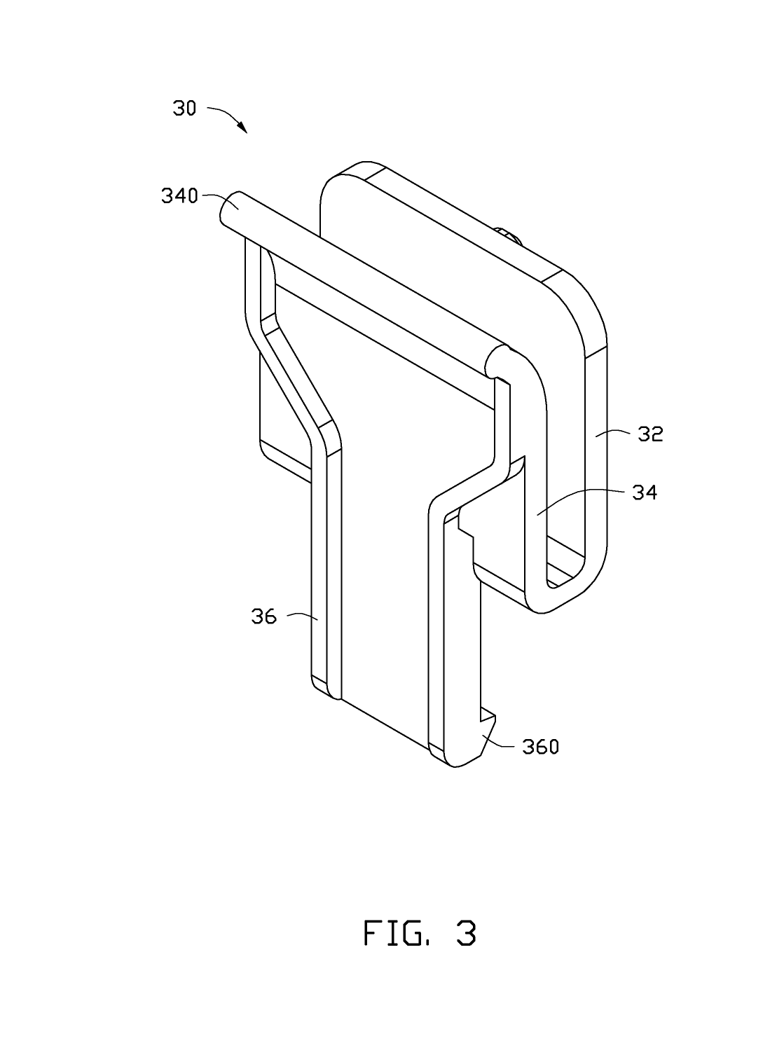

Referring to FIG. 2 and FIG. 3, the retaining member 30 includes a substantially rectangular mounting plate 32, an operation portion 34 extending out and up from a bottom side of the mounting plate 32, and a locking portion 36 extending down from a middle of a bottom of the operation portion 34. The operation portion 34 is parallel to the mounting plate 32. Two resilient mushroom shaped fixing portions 320 extend from a side surface of the mounting plate 32 opposite to the operation portion 34. A handle 340 slantingly extends out from a top of the operation portion 34. The locking portion 36 includes a hook 360 formed at a bottom of the locking portion 36. The hook 360 includes a sloped guiding surface 362 at a bottom of the hook 360 and a stop surface 364 opposite to the guiding surface 362.

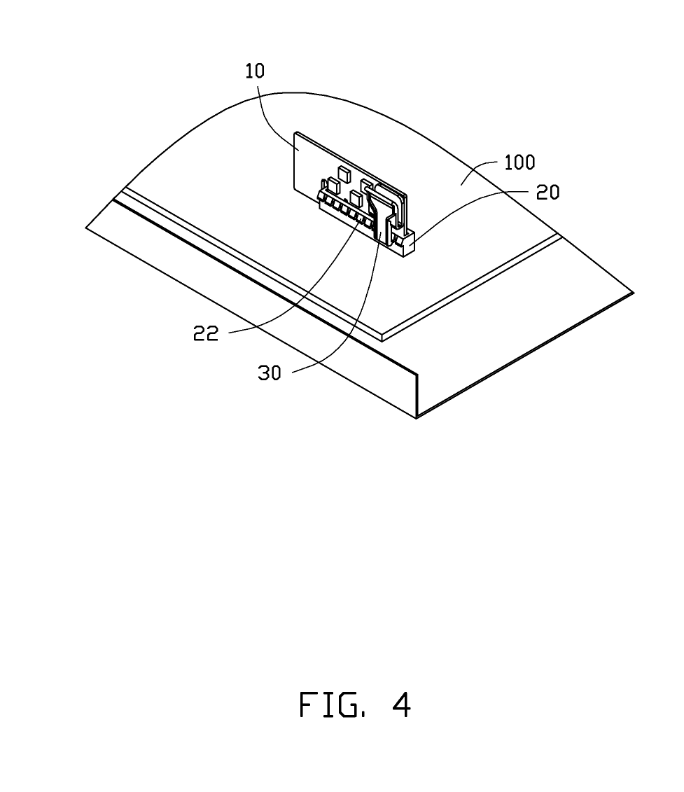

Referring to FIG. 4, in assembly, the fixing portions 320 are inserted into the fixing holes 120, to fix the retaining member 30 to one side of the expansion card 10. The expansion card 10 is plugged in the socket 20. The guiding surface 362 slidably abuts against the flange 22 to deform the locking portion 36 away from the socket 20, until the hook 360 rides over the flange 22. The stop surface 364 is blocked by a bottom of the flange 22. The hook 360 is thus locked to the flange 22. Therefore, the expansion card 10 is retained in the socket 20.

In releasing the expansion card 10, the handle 340 is deformed toward the mounting plate 32 until the hook 360 is released from the flange 22. The expansion card 10 can then be easily pulled out from the socket 20.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A mounting apparatus for mounting an expansion card to a socket, the socket forming a flange at a side of the socket, the mounting apparatus comprising:
a retaining member comprising a mounting plate to be fixed to the expansion card, an operation portion extending from a side of the mounting plate, and a locking portion extending down from the operation portion;
wherein, in mounting the expansion card, the expansion card is plugged in the socket, and the locking portion is locked to the flange.

2. The mounting apparatus of claim 1, wherein the operation portion extends out and up from a bottom side of the mounting plate.

3. The mounting apparatus of claim 2, wherein the operation portion is parallel to the mounting plate.

4. The mounting apparatus of claim 2, wherein a handle slantingly extends out from a top of the operation portion.

5. The mounting apparatus of claim 1, wherein two resilient mushroom shaped fixing portions are formed on a side surface of the mounting plate opposite to the operation portion, for fixing the retaining member to the expansion card.

6. The mounting apparatus of claim 1, wherein the locking portion comprises a hook formed at a bottom of the locking portion, the hook comprises a sloped guiding surface at a bottom of the hook and a stop surface opposite to the guiding surface, when the expansion card is plugged in the socket, the guiding surface abuts against the flange to deform the locking portion away from the socket, until the hook rides over the flange, the stop surface is blocked by a bottom of the flange.

7. An assembly comprising:
a socket set on a motherboard, the socket forming a flange at a side of the socket;
an expansion card plugged in the socket; and
a retaining member comprising a mounting plate fixed to the expansion card, an operation portion extending from a side of the mounting plate, and a locking portion extending down from the operation portion;
wherein the locking portion is locked to the flange.

8. The assembly of claim 7, wherein the operation portion extends out and up from a bottom side of the mounting plate.

9. The assembly of claim 8, wherein the operation portion is parallel to the mounting plate.

10. The assembly of claim 8, wherein a handle slantingly extends out from a top of the operation portion. 11. The assembly of claim 7, wherein the expansion card defines two fixing holes, two resilient mushroom shaped fixing portions are formed on a side surface of the mounting plate opposite to the operation portion, for fixing in the fixing holes of the expansion card.

11. The assembly of claim 7, wherein the locking portion comprises a hook formed at a bottom of the locking portion, the hook comprises a sloped guiding surface at a bottom of the hook and a stop surface opposite to the guiding surface, when the expansion card is plugged in the socket, the guiding surface abuts against the flange to deform the locking portion away from the socket, until the hook rides over the flange, the stop surface is blocked by a bottom of the flange.
